(19) United States
(12) Patent Application Publication
(10) Pub. No.: US 2015/0307731 A1
(43) Pub. Date: Oct. 29, 2015

(54) Hydrophobic, Superhydrophobic, Oleophobic, and Paintphobic Tools, Devices, Systems, and Methods Using Solvent Resistant, Ultraviolet Resistant, Water Resistant, and Food Safe Phobic and Superphobic Coatings

(71) Applicants: Adam John Bechtel, Lafayette, IN (US); Brandon Scott Bechtel, Lafayette, IN (US)

(72) Inventors: Adam John Bechtel, Lafayette, IN (US); Brandon Scott Bechtel, Lafayette, IN (US)

(21) Appl. No.: 14/553,891

(22) Filed: Nov. 25, 2014

Related U.S. Application Data
(60) Provisional application No. 61/963,170, filed on Nov. 25, 2013.

(51) Int. Cl. C09D 129/04; B05C 17/00; F16K 15/00; B05C 17/02

(52) U.S. Cl. CPC C09D 129/04; B05C 17/02; B05C 17/00; F16K 15/00

(57) ABSTRACT

A means for applying and beneficially using durable hydrophobic, superhydrophobic, oleophobic, superoleophobic, paintphobic, superpaintphobic, tunable liquid-phobic and superliquidphobic coatings, collectively called X-phobic coatings, which are solvent resistant, ultraviolet light resistant, water resistant, and food safe is claimed while also improving adhesion and durability of the materials used to create the desired properties. These X-phobic surface coatings are usefully applied to a host of tools, devices, systems, and methods which benefit from the coatings, including but not limited to equipment used in painting and applying protective coatings. These include storage containers of containers used during coating or painting such as roller pans, buckets, and trim cups. The inventive coating is also taught as being useful in paint brushes, knives, rollers, pads, sprayers, pumps, tubing, valves, sensors, eye or face protection, clothing and protection equipment worn by workers, application systems, robotic application systems, application facilities, masking and shielding materials and devices, and similar equipment.

This application is related to and claims priority to U.S. Provisional Patent application No. 61/963,170 entitled “Hydrophobic, Superhydrophobic, Oleophobic, and Paintphobic Tools, Devices, Systems, and Methods Using Solvent Resistant, Ultraviolet Resistant, Water Resistant, and Food Safe Phobic and Superphobic Coatings” filed 25 Nov. 2013, herein incorporated by reference.

### FIELD OF INVENTION

The device has application in the construction trades, manufacturing, food storage, pharmaceuticals, consumer and industrial packaging, electronics, land, air, and waterborne vehicles, clothing, and more, including inventions for other purposes which may not reasonably be foreseen at the present time and state of the art. In fact, any additional area in which a solvent resistant, ultraviolet light resistant, or food safe durable superhydrophobic or other phobic surface is advantageous, saving cost, labor, or protecting an object, represents an application for, and part of, the present invention. Previous superhydrophobic surfaces known in the art have provided an effective, yet limited, means of repelling water and oil based compounds from a surface. However, these surfaces suffer from rapid deterioration when exposed to solvents, detergents, ultraviolet light, other chemicals, or even physical rubbing or sufficient friction across the surface. Additionally current superhydrophobic surfaces are not food safe. These qualities greatly limit the spectrum of applications across which the previously known superhydrophobic surfaces may be used. The coatings which are subject of the present invention are not subject to these rather serious limitations, and the inventive coatings of the present invention represent coatings durable enough for heavy and widespread use.

Advances in nanotechnology and improved understanding of how physical surface structures resist wetting by various liquids have made improved superhydrophobic and oleophobic surfaces possible. The invention teaches applying and beneficially using durable hydrophobic, superhydrophobic, oleophobic, superoleophobic, paintphobic, superpaintphobic, tunable liquid-phobic and superliquidphobic coatings, collectively called X-phobic coatings, which are solvent resistant, ultraviolet light resistant, water resistant, and food safe while also improving adhesion and durability of the materials used to create the desired properties. As part of this disclosure and to be precise, these X-phobic coatings are distinctly different, and thus substantially, differentiated from old and widely known “non-stick” surfaces, such as Teflon. The use of Teflon in containers, pans, paint brushes, and other tools is widely known in the art but distinctly different from the present invention because of very low, if any functional useful hydrophobic properties are demonstrated relative to the new options both known in the art and intended to be used in the present invention.

For example, and when said inventive coatings are used in the present inventions to facilitate new construction and maintenance painting of dwellings, offices, or other multi-room or multi-dwelling buildings, the time required for cleanup of equipment used to do the job will be largely eliminated. Since paint cannot wet or stick to a roller bucket, for example, cleanup is simply a matter of pouring out the unused paint and putting the roller bucket away. Rather than wash a paint brush embodying the present invention, the brush needs only shaken clean before the wet tips of its bristles may be washed more quickly using water or appropriate solvent. Moreover, the inventive brush will be easier to use, always emerging from a dip into wet paint with exactly the right amount of paint in the untreated portions of the bristles, as if the painter had perfect skills to dip the brush at exactly the right depth each time. The time and labor necessary to complete the job, including cleaning equipment, noted as part of the total cost involved, is reduced by the present invention. Moreover, premature equipment replacement caused by poor cleaning eventual paint build up is prevented by the present invention.

The object of the present invention when used in painting equipment is to reduce these labor and equipment costs while assuring that the necessary equipment is always clean and ready for use.

As noted, a second object of the present invention is to overcome variations in skill level among painters. Preferred embodiments of paint brushes, rollers, paint pads, and other painting tools will automatically avoid soaking up excess paint. This results in less drips, runs and reduces the amount of paint which may creep up the handle or run down when painting ceilings and undersides. Painters will not need to stop work to clean up as many drips, if any.

Additional objects of the present invention including creation of a useful X-phobic or superphobic surface which is resistant to solvents, ultraviolet light, and water.

An additional object of the present invention is to make superhydrophobic coatings food safe.

An additional object of the present invention is to improve adhesion of the materials used to form the superhydrophobic surface, which is to say adhesive bonding between a selected X-phobic material and a surface sufficient to make the invention work, and also to protect the nanoparticles which produce the desired surface property. In contrast, the hydrophobic and superhydrophobic coatings taught in the prior art easily rub off surfaces, often merely by rubbing lightly with a finger. Some of them are so delicate they simply wash off relatively under a steady stream of fluid types, even including water for a few of them.

Finally, an object of the present invention is to apply the inventive coatings in a useful way, including applications in painting tools, containers, and other equipment, additional useful objects and machines, and a variety of methods, all of which benefit from this platform technology which can change surface properties in the inventively useful way.

With respect to the painting and coatings industry, an additional object of the present invention is to control the flow of paint or coating material on or through equipment used for application and storage of painting and coating materials.

An additional object of the present invention in the painting and coatings industry is to reduce the amount of paint being disposed of during cleanup of a job, generating secondary environmental benefits.

### BACKGROUND OF THE INVENTION

Advances in the technology to create hydrophobic surfaces have resulted in superhydrophobic surfaces. The phobic and superphobic property of a coated surface is measurable by those skilled in the art. Water is said to “bead” or “bead up” on hydrophobic surfaces, and objectively determining how much it beads up is the idea behind the generally accepted measurement method. This qualification of hydrophobic properties of different surfaces requires measuring the angle between the plane of the material and the lower or underside tangent of a somewhat spherical drop of water sitting on the material's surface, starting where the water bead parts from the surface. The unusual effect is very pronounced for the more technologically advanced superhydrophobic surfaces developed using nanoscience. Here, the small beads of water may appear almost like tiny silver balls rolling about on the superhydrophobic surface as it is tilted back and forth. For use in a roller pan or trip cup, the value of the dramatic surface property is understandable, because turning the pan upside down would empty 100 percent of the contents, meaning it is self-cleaning.

It is important to teach the X-phobic properties of the present invention as largely the result of physical and dimensional construction, not necessarily the result of any particular material such as plastic, silicon, metal, glass, and so forth. To this point, it is known in the art that living plants and even certain animals grow very small microscopic surface structures, thus organic chemical compound based, which exhibit the X-phobic properties. In the field of advanced solar cell improvement, fine hair like or brush like surface features have been created to channel light and these are so fine as to also exhibit the X-phobic properties of the present invention.

As such, given that many known structural forms exhibit a variety of X-phobic properties and the production of which is well known in the art, and therefore need not be recited. The present invention will apply and utilize these known surface structures in a practical manner to achieve the various objects of the present invention. Where examples of a known X-phobic structure of compound are offered, it is not the intention of the inventors to limit the application to just that example solution.

Chemical compositions also exhibit limited X-phobic properties as well without necessarily exhibiting the physical surface patterns and geometries described above. The polyurethane, polymer, even organic, or equivalent windshield rain treatments which claim to bead up water so it is easily blown off the windshield and does not wet to obscure driver vision is one such example. Another example is the polymer coating used to create the fingerprint resistant touch screen coating on some smart phones and mobile computing devices. These permit a user to touch the screen repeatedly with normal oil and perspiration on finger tips while leaving a minimum of smudges and prints. Of course, basic hydrophobic compounds, like glass was or even Terflon, are well known to those skilled in the art. These chemical compound derived material selections, while falling into the X-phobic category, typically do not exhibit X-phobic properties as high as those X-phobic properties created through geometric or mechanical nanostructure; nevertheless, they may also be used for embodiments of the present invention if the user is agreeable to accept their X-phobic capability.

As noted above with respect to the variety of nano and physical structures which will render X-phobic results, given that many known chemical compounds exhibit a variety of X-phobic properties, albeit perhaps with lessor effectiveness than the nanostructures, these compounds are which in the art and all choices need not be recited. The present invent seeks to apply and utilize them in a practical manner for the practical objects of the present invention. Where examples of a known X-phobic structure of compound are offered, it is not the intention of the inventors to limit the application to just that example solution.

Unfortunately, even the superhydrophobic coatings of the most recent prior art will dissolve when placed in contact with paint, rendering the prior art unsuitable as a coating for painting equipment. If these earlier coatings appear to work at all, it is only with the brevity of a parlor trick, and they will fail in their purpose almost immediately thereafter.

In U.S. Pat. No. 8,338,351 B2, titled Coating compositions for producing transparent super hydrophobic surfaces, Kanagasabapathy et.al. teach near transparent hydrophobic coatings with 1.65 degree contact angles. Contact angle measures the angle between surface plane and the tangent to droplet triple point, where the gas, solid, and liquid all meet.

This 351 patent references applying nanoparticles of a fluorinated silsesquioxane having a particle size the range of about 7 nm to about 600 nm dispersed in a solvent to a surface, but creating only a “temporary” hydrophobic surface. The property is useful, but needs to be sustainable for practical commercialization. In general, the materials used to produce the property, while physically structured into the hydrophobic array and spacing, are easily dissolved, broken down by many forms of energy, or even physically destroyed or removed by rubbing.

Advances in the technology to create hydrophobic surfaces have resulted in superhydrophobic surfaces, not necessarily considered temporary but still having minimal durability, if any. Product reviews of early commercial offerings tended to be highly critical of how short-lived the spray on coatings were.

U.S. Pat. No. 3,532,534 A teaches its title, which reads “Method of making a waterproof polyvinyl alcohol coated paper.” In this old patent, inventor Edmund Wolff describes PVA as easily attaching to cellulose and providing a beneficial, bright, and light weight surface finish for printing. He then explains how PVA is soluble, thus brochures and other materials printed on PVA coated stock are not inherently waterproof. Wolff's inventive step is to then treat the dry PVA coated paper with an aqueous acidic agent which insolubilizes the PVA. His patent forms the basis for today's commonplace use of polyvinyl alcohol or “PVA” on the surface of paper.

More recently, Lan Decastro et.al. teach use of PVA coating of medicinal compounds specifically to trick them into solubility like behavior using the ready solubility property of PVA, Their pending application number WO 1996025919 A1 titled “Aerosols containing beclomethasone nanoparticle dispersions” by coating the medicine and mixing them into an aerosol as a delivery system to deliver medicine to the human respiratory tract. Again, as a coating for nanoparticles, the solubility is useful but for achieving the objective of the present invention of creating a durable superhydrophobic surface, it is disastrous.

The present invention teaches use of the adhesive and thin film coating properties of PVA to encapsulate useful nanoparticles, but then passivating the coated particles to make them insoluble. In the present invention, PVA coated suitable nanoparticles are adhesively attached to a surface desired to have superhydrophobic properties. These PVA coated nanoparticles are then insolubilized using one of many methods known in the art, such as treatment with an aqueous acidic agent, or passivated and thus insolubilized using a more sophisticated secondary coating.

In the present invention, the inventive result will block water, other destructive solvents, and even energetic ultraviolet radiation from destroying the tiny nanostructures and molecules which form the inventive superphobic surface. Moreover, with these protective understandings, the particle sizes and thus the phobic surface property can be dimensionally tuned or optimized for a variety of phobic properties, including superhydrophobic, paintphobic, and even customized X-phobic coatings. This advances the best of the previously known hydrophobic surface preparations wherein water may not immediately destroy or remove the nanoparticles per se, but additional water or other solvents will dissolve the coating on the nanoparticles or, with equal destructive effect, dissolve the adhesive mechanism attaching them to the surface before washing them away.

In U.S. Pat. No. 8,338,351 B2—Coating compositions for producing transparent super-hydrophobic surfaces—inventors Subbareddy Kanagasabapathy et.al. describe transparent superhydrophobic coatings for glass which eliminate or otherwise ease the work required to clean windows or windshields. The threshold for their claimed contact angle is described as greater than 165 degrees, the uncorrected contact angle is measured between the plane of the glass surface and the tangent along the water droplet referenced (anchored) to the contact point between water and surface, where the drop is sitting on the glass surface, and where the gravity vector is normal to that surface. The compositions taught are comprised of silsesquioxanes containing adhesion promoter groups and low surface energy groups. These are capable of forming the uncharged or relatively low charged physical nano structure capable of exhibiting the desired superhydrophobic property; however, those skilled in the art will easily recognize the patented composition as easily damaged by a variety of influences such as ultraviolet light, most hydrocarbon based solvents, other surfactants and solvents, or relatively light frictional forces. If a superhydrophobic coating need not be transparent, the number and types of available materials expands considerably. To this point, their first independent claim specifically uses the word “temporary” when referring to the superhydrophobic characteristics and this limitation carries through all dependent claims.

In U.S. Pat. No. 8,258,206 B2—Hydrophobic coating compositions for drag reduction—this referenced '206 patents, the same inventors teach a hydrophobic coating for drag reduction. This property is described by the inventors as beneficial for “pipe surfaces, exterior boat surfaces, and in any other applications.” Having escaped the transparency limitation of their other invention, this patent describes better resistance to light wear or “abrasion” and some resistance to damage from ultraviolet light. The composition is described as “almost clear” and the critical angle greater than 165 degrees is again referenced as the threshold for validating a “hydrophobic” [sic] property (inconsistency noted). Note the inventor of the '206 patent defines an angle which is actually superhydrophobic. The claimed coating reduces drag in water. The patent is generally silent with respect to the effects of or surface damage caused by other liquids, solvents, surfactants, and no forth; and the objective of the present art addressed this problem to permit use in tools and containers. Finally, the '206 patent contains two independent claims teaching two compositions. First, the elements used to create the composition are, “a solvent selected from the group consisting of acetone, an aliphatic hydrocarbon, an alcohol, a hydrocarbon, and mineral spirits; a plurality of nanoparticles selected from the group consisting of fumed silica, hydrophobic titania, and zinc oxide; and a UV stable hydrophobic perfluoro alkyl substituted acrylic polymer. Second, the composition is comprised of “a solvent selected from the group consisting of acetone, an aliphatic hydrocarbon, an alcohol, and mineral spirits; a plurality of nanoparticles selected from the group consisting of fumed silica and hydrophobic titania, a plurality of zinc oxide nanoparticles; and a hydrophobic polymer selected from the group consisting of an acrylic, a hydroxyl-functional silicone polyacrylate, a polycarboxylate, a polyether, and a polyvinylacetate.” The phrase, “hydrophobic titania” is believed to refer to titanium dioxide (TiO₂) particles sized to produce the desired hydrophobic property. Titanium dioxide nanoparticles are widely manufactured for use in a wide range of applications.

In WO 2009055004 A1—Anti-graffiti Coating—an anti-graffiti coating is the subject of an invention of Bo H Gimvang, but is not phobic or superphobic. Gimvang does, however, does teach a surface penetrating coating which “possesses a surface tension higher than the surface tension of the surface to which it is applied, whereby paint applied to said coating is easily removed.” Consistent with the known weaknesses of hydrophobic and superhydrophobic coatings of the prior art, inventor Gimvang abandons the physics of the phobic property in exchange for durability and easy cleaning, which must both be present if a user of the invention is expected to rub off the graffiti, no matter how easy is efforts may be. In comparison, the present invention delivers a phobic or hydrophobic, tunable surface coating, which offers the resistances and durability necessary to become a practical coating for many tools, objects, and methods.

### SUMMARY DESCRIPTION OF THE INVENTION

By adding a coating of polymer such as Polyvinyl Alcohol, or an equivalent substance, over the surface of appropriate sized nanoparticles, the otherwise unstable and sometimes unsafe nanoparticles become coated and protected against solvents, which might otherwise remove them, and ultraviolet light, which might otherwise cause molecular breakdown. Desirable phobic properties and their related physical geometries and other properties necessary to generate superhydrophobic, or other phobic, effects are preserved by the invention. The coating in the preferred embodiment additionally provides a non-toxic, generally non-reactive, and food safe protective coating around the nano particles and improves adhesion of the particles to a surface. An insolubilizer, most of which are know in the art, then may be added to improve water resistance of the coating and prevent hydrolysis from breaking down the coating. The durability and resistance to ultraviolet energy and insolubility are all improvements versus the current known phobic compounds and nanostructures. The inventive result is ideal for use in painting tools and containers, including masking materials, because of its ability to resist solvents and other chemicals used in paints along with the capacity to endure the environmental exposures related to daily commercial use. The invention is also applicable to a host of other products and methods such as packaging and containers, refrigeration and storage equipment, fluid power, fluid control, and fluid transport solutions, clothing, all types of vehicles, construction tools and equipment, drilling and mining equipment, physical structures, buildings, and homes, electronic passivation, touch screens and control panels, and more.

Maximum ability to repel or resist water and wetting, under the broader definition of being said to be hydrophobic, has its roots in glass which may never require cleaning and clothing or footwear which keeps the wearer dry. Oleophobic, which is the analogous property applied to oil (Latin oleum “oil”) based compounds, is sometimes also referred to using the term lipophobic (Greek lipid “fat”). A classic example of why an oleophobic surface would be desirable would be to resist fingerprints, which are often generated by skin oil, for example, on a touch pad or smart phone screen. Noting these various definitions, it is important to note that new technologies, such as surface structures, nanoparticles, nanochemistry, and so forth which produce these properties do so through a resulting physical nanostructure which exhibits required electrical properties and forces on the resisted compound. For example, application of the inventive science could produce a Freon-phobic surface, perhaps for the inside of certain parts of a refrigeration system. In this regard, the subject matter of the present invention has broad applications beyond to production of durable, non-dissolving hydrophobic materials and surfaces. The phenomenon or x-phobic property is related to the geometry and physics of the surface, not purely its chemistry or summation of forces in any particular material; therefore, rather that list all forms of x-phobic property, convenience and word economy can be achieved by understanding that the invention applied to achieve a superhydrophobic property may be applied to the other types of phobic properties equally well; therefore, it shall be understood that the inventor uses the terms “hydrophobic” and “superhydrophobic” throughout this specification in a broader sense than usual, not merely being limited to water, but rather including all particulate or nano-formation surface geometries which could create oleophobic, solvent-phobic, hydrophobic, hydrocarbinphobic, etc. properties.

### Purpose of Invention

When prior art superhydrophobic materials were applied to a surface the effects were always limited and temporary. These restrictions reduce the utility of superhydrophobic coatings in practice due to the cost and time required for frequently reapplying the superhydrophobic material after each deterioration to address the limited number of circumstances where superhydrophobic materials are safe, non-reactive, or otherwise possible to use.

The preferred embodiment of the present invention provides a more durable, versatile, and resistant superhydrophobic material. The inventive coating needs be applied only one time and reduces application costs and maintenance. The solvent resistance and ultraviolet light resistance of the invention allow superhydrophobic coatings to be applied in a broader range of surfaces which previously were impractical to coat due to the instability of previous superhydrophobic coatings. For example, outdoor graffiti resistant walls or the surfaces of boats would be able to take advantage of hydrophobic solutions without concerns about degradation in sunlight.

The present invention's food safety allows the coating to be used in applications where traditional superhydrophobic coatings would be deemed unsafe. For this and many other uses, the present inventions resistance to solvents is highly desirable, and for yet other uses, the ability not to degrade when exposed to ultraviolet radiation is useful. There are many examples of how devices, methods, and structures which have been imparted with the inventive phobic coatings and properties will save cost by reducing energy consumption, eliminating human labor, and protecting materials

For example, in the painting industry, when painting at multiple job sites, time is often required for cleaning up after a job. Moreover, a lack of job site cleaning facilities can preclude the advantages of cleanup at the job site Wet brushes, rollers, and paint containers which may have wet paint on their exteriors are difficult to collect and carry at one time, and may contact walls, doorways, transport vehicles, or other objects not intended to be painted or contaminated with paint or coatings.

The present invention addresses a paint vessel, such as a roller pan or trim cup, and thus when the inner X-phobic surface is created that is equivalently paintphobic, which is to say the paint behaves like water on a hydrophobic or superhydrophobic surface, the paint may be emptied out of the vessel and leave minimal paint or residue of paint. Traditional cleanup, normally washing the vessel with plenty of water and some detergent or perhaps other solvents, is limited in a paintphobic vessel to simply dumping its contents. In the worst case, a wipe with a towel or a very quick rinse would remove paint from any areas where the paintphobic surface was degraded or compromised. As such, the utility of having a paintphobic surface in a roller pan, trim cup, or other vessel is demonstrated.

As noted, some superhydrophobic material solutions are known already in the art, but are almost exclusively engineered to repel water, rain, ice, snow, or water based suspensions such as mud or road spray. Paint is distinguished from these water forms by the inclusion of detergents and emulsifiers specifically added to improve the wetting function of the liquid, specifically to make it easier and faster to apply to the surface being painted.

Hydrophobic, Superhydrophobic, superoleophobic surfaces, all of which are created by coatings or other known means, will all work with paint at various levels of utility to the present invention but do not necessarily represent the preferred embodiment of the present invention because they are easily dissolved, damaged, or otherwise quickly worn away with light abrasion as noted earlier. The tiny structures which create the effect are indeed fragile and easily degraded, and the adhesive attachment methods generally weak or often subject to being dissolved by many chemicals generally found in paint compositions and other commonly used chemicals

Paintphobic and superpaintphobic technology better proximate the preferred embodiment of the present invention. Paintphobic compounds and surfaces will almost always be hydrophobic or even superhydrophobic, but most of the commercialized superhydrophobic surfaces are not paintphobic; to the contrary, most are instantly destroyed by paint, even those which are water based. These properties will be understood by those skilled in the art and having understanding of creating surface structures and addressing differences in paint compositions. Moreover, it is understood that a preferred embodiment for one formulation of paint, for example, water based latex, may not be a preferred embodiment for oil based paint, or even water based enamel. As such the lexicography of the present invention, specifically words like paintphobic and superpaintphobic, refers to properties which cause a broad range liquids and compositions of liquids used for painting or intended as surface protective coatings to bead up rather than wet, and not the specific surface features or precise compositions which generate those properties with specific paint types and formulations.

Flat, semi-gloss, gloss, and enamel (high gloss) latex paints are common to commercial and dwelling construction, and widely utilized for interior space drywall and wood coatings. As such, a preferred embodiment of the present invention is superpaintphobic surfaced paint application devices, systems, and methods.

### SUMMARY DESCRIPTION OF THE DRAWINGS

FIG. 1 A nano particle suspended in an aqueous solution.

FIG. 2 Through hydrolysis, a polymer's bonds are cleaved and the polymer is divided into monomers which are suspended in the aqueous solution. At this point, additional chemicals may be added to alter or add desired properties of the coating. In the alternative, they may be added in a later step.

FIG. 3 During dehydration the monomers polymerize forming a solid, protective coating which completely encloses the entire nano particle.

FIG. 4 Prior to dehydration, and if not previously added as an option during the step depicted in FIG. 2 or in addition to those chemicals, additional chemicals may be added to alter the desired properties of the final coating, providing a passivation layer which acts to insolubilize the final superhydrophobic surface.

FIG. 5 is an embodiment of the present invention applied to a paintbrush. The brush is coated with a paintphobic or superpaintphobic coating from the handle up to the final few inches of the bristles, protecting the portion of the brush used for handling, but allowing for the accumulation of paint on the bristles used for application of paint to the intended medium.

FIG. 6 shows two paint roller pans of the type generally used by consumers and sometimes by professional painters; however, the subject paint pans have superpaintphobic coatings so they will empty to a clean condition simply by pouring out the contents.

### DETAILED DESCRIPTION OF THE DRAWINGS

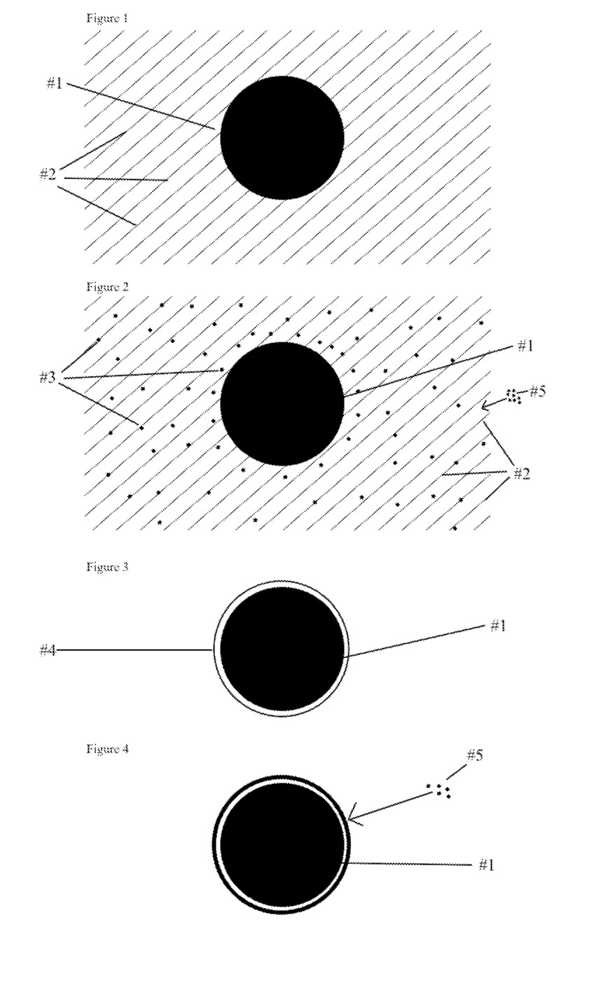

FIG. 1 A nano particle (1) of titanium dioxide, silicone dioxide or an equivalent in a preferred embodiment of the invention, or other particle type for alternative embodiments, and where this appropriate sized particle is suspended in an aqueous solution (2)

FIG. 2 A polymer such as polyvinyl alcohol (PVOH or PVA) in a preferred embodiment or other suitable soluble adhesive chemical is added to the aqueous solution (2). Through the process of hydrolysis, the bonds of this polymer are cleaved and the polymer is divided into single molecules or monomers (3), vinyl alcohol in the PVOH case. These monomers (3) are suspended in the aqueous solution (2) and surround the nano particle (1). At this time the aqueous solution (2) may be applied to any surface through means of spraying, dipping, brushing, rolling, infusing, casting or any other known or not yet known application method. At this point, additional chemicals may be added to alter or add desired properties of the coating. In the alternative, they may be added in a later step.

In an alternative embodiment of the present invention, the coated nanoparticles described in the previous paragraph may be singulated into a powder like material for future use. Examples of these uses may include but are not limited to inclusion into other paints and coatings, electrical charge applied surface coatings, dry spraying onto surfaces of adhesive films, incorporation into pastes such as antiperspirants, mixed into molten materials, molded or imbedded into plastics, sprayed onto molten materials, and so forth.

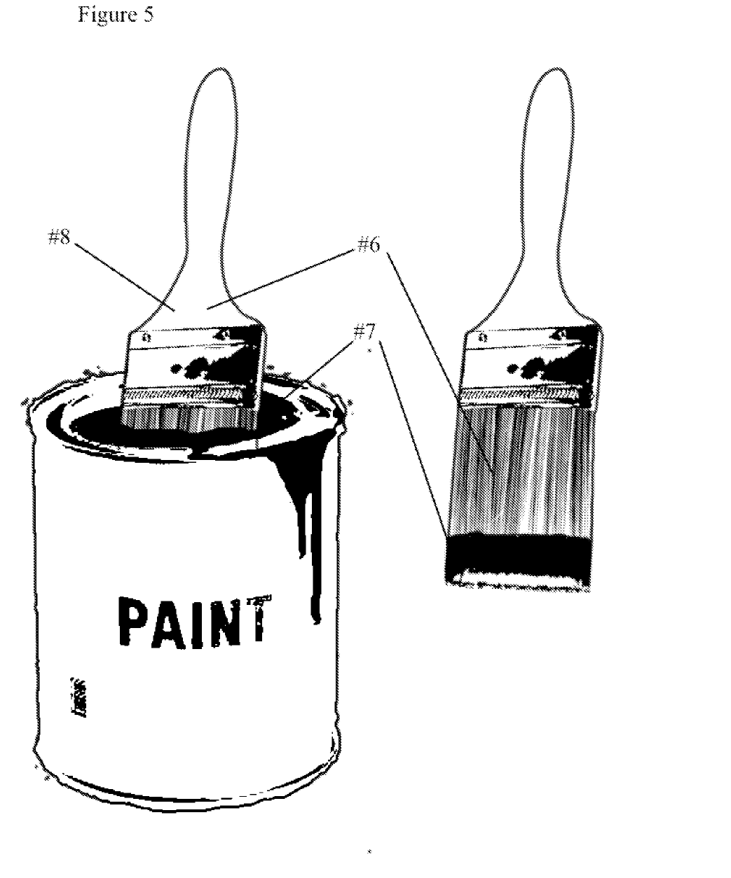

FIG. 3 During the dehydration of the aqueous solution (2), the monomers (3), vinyl alcohol in the PVOH case, polymerize around the nanoparticle (1), forming a cross-linked coating (4) surrounding the entire particle. In the PVOH embodiment, this coating (4) is resistant to solvents and ultraviolet light. PVOH coatings also are food safe and improve adhesion of the nanoparticles (1) to a surface. The polymer coating (4) protects the nanoparticle (1) and shields it from directly touching any surfaces outside of the polymer coating (4), while still maintaining the superhydrophobic properties created from its physical structure.

FIG. 4 Prior to, after, or during the dehydration process, and if not previously added as an option during the step depicted in FIG. 2 or in addition to those chemicals, additional chemicals (5) may be added to alter the properties of polymer coating (4). In the PVOH case, an insolubilizer, such as Amino Resins, Glyoxal, Zirconium Salts or others may be added to improve the water resistance of the PVOH coating. While the nano particles (1) are water resistant, the PVOH coating is not water resistant unless farther treated.

FIG. 5 A preferred embodiment of the invention depicted in FIG. 5 is a paintbrush (8) and typical subject of the present invention. The handle and upper portion of the bristles (1) have been coated with a superpaintphobic coating (6) which protects the brush from the accumulation of paint (7) or other coating, during use. This figure illustrates the brush being dipped into a can of paint far deeper than the useful end of the bristles requires, and, in turn shows the brush after removal wherein paint only adheres to the operative or useful portion of the bristles having been wetted with paint (7). The utilitarian coating and subject of the present invention is applied to the areas of the painting tool which are used for handling and not application of the chosen paint or surface coating material. The lower portion of the bristles is not coated with any paintphobic or superpaintphobic composition, allowing for the accumulation of a paint or coating material on the bristles, and thus ready to be applied to the surface the individual using the brush is painting or coating.

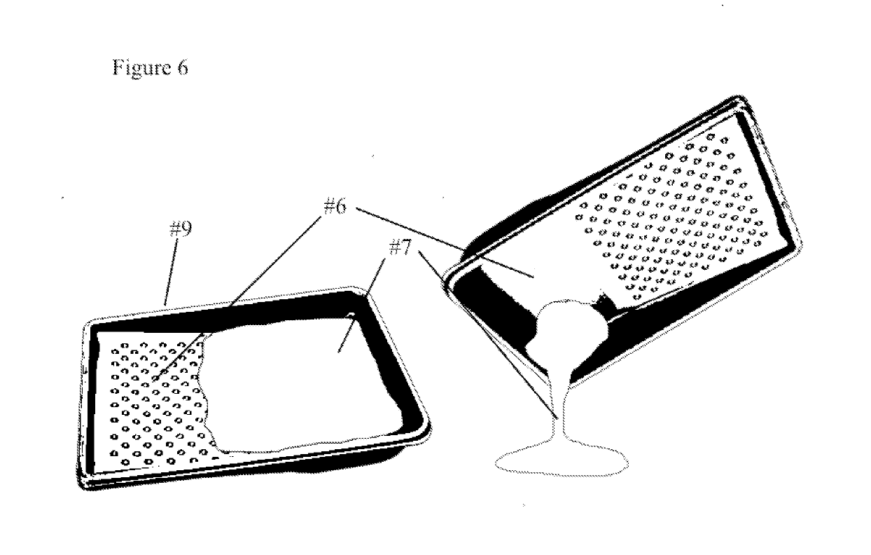

FIG. 6 shows two paint roller pans (9) of the type generally used by consumers and sometimes by professional painters containing paint (7); however, the subject paint pans each have a superpaintphobic coating (6). The paint pan at the right is being emptied and demonstrates how it empties to a clean and ready-to-use again condition without further washing or wiping by the painter simply by pouring out its contents.

The disclosures and teachings herein have been intended as illustrative and descriptive of the various elements and understanding one skilled in the art would normally employ when creating various embodiments of the present invention. This includes the entire field of X-phobic choices, some of which will be developed or improved in the future in ways the inventor cannot reasonably anticipate or forsee. As such, these X-phobic solutions are intended to be included within the scope of the present invention. The same is true for the ever growing field of adhesives. As such, the inventor cannot reasonably foresee future adhesive solutions and options; nevertheless, these are also intended to be included within the scope of the present invention.

We claim:

1. A container to hold a liquid comprised of a vessel with sides to prevent spilling and a surface coating which is X-phobic.

2. The invention in claim 1 wherein the X-phobic property is selected from the group consisting of hydrophobic, superhydrophobic, oleophobic, and paintphobic.

3. The invention in claim 1 wherein the container is used to hold paint, stain, protective coating liquid, or any combination thereof.

4. The invention in claim 1 wherein the X-phobic coating material adhesion is sufficient to prevent washing off or otherwise degrading during normal container use, environmental exposure, and product life.

5. The invention in claim 1 wherein the X-phobic material surface is bonded to container surfaces using a mechanism selected from the group consisting of glue, tape, polymers, infusion, imbedding, chemically bonding, and molding.

6. The invention in claim 1 wherein the X-phobic coating is selected from the group consisting of nanoparticles, oils, flourocarbons, and polymers.

7. A coating material applicator comprised of fibers partially coated with X-phobic surface coating.

8. The invention in claim 7 wherein the X-phobic property is selected from hydrophobic, superhydrophobic, oleophobic, and paintphobic.

9. The invention in claim 7 wherein the coating material applicator is a paint brush.

10. The invention in claim 7 wherein the coating material applicator is a paint roller.

11. The invention in claim 7 wherein the coating material applicator is a painting pad.

12. The invention in claim 7 wherein the coating material applicator is supplied with coating material through a feed tube in mechanical communication with said coating material applicator and a container of liquid coating material.

13. The invention in claim 7 wherein the adhesion of the X-phobic coating material will reduce washing away or otherwise degrading to a point rendering the invention non-functional during normal use and product life.

14. The invention in claim 7 wherein the X-phobic material surface is bonded to coating material applicator surfaces using a mechanism selected from the group consisting of glue, tape, polymers, infusion, imbedding, chemically bonding, and molding.

15. The invention in claim 7 wherein the X-phobic coating is selected from the group consisting of nanoparticles, oils, flourocarbons, and polymers.

16. A liquid transport system for transfer a liquid comprised of at least one tube with a surface coating which is X-phobic.

17. The invention in claim 16 wherein the X-phobic property is selected from the group consisting of hydrophobic, superhydrophobic, oleophobic, and paintphobic.

18. The invention in claim 16 wherein the liquid transport system includes at least one valve, wherein said valve may be in the form of a check valve integrated into a quick disconnect.

19. The invention in claim 16 wherein the X-phobic material surface is bonded to liquid transport system surfaces using a mechanism selected from the group consisting of glue, tape, polymers, infusion, imbedding, chemically bonding, and molding.

20. The invention in claim 16 wherein the X-phobic coating is selected from the group consisting of nanoparticles, oils, flourocarbons, and polymers.
